(19) United States
(12) Patent Application Publication
(10) Pub. No.: US 2022/0267648 A1
(43) Pub. Date: Aug. 25, 2022

(54) PRE-PASTED WALL COVER AND A METHOD OF PRODUCING THE SAME

(71) Applicant: Ahlstrom-Munksjö Oyj, Helsinki (FI)

(72) Inventors: Fernando Mora Villarrubia, Grenoble (FR); Xiling Zeng, Shanghai (CN); Wendy Wang, Binzhou City (CN); Kevin Li, Binzhou City (CN)

(21) Appl. No.: 17/637,666

(22) PCT Filed: Aug. 24, 2020
(86) PCT No.: PCT/FI2020/050548

§ 371 Date: Feb. 23, 2022

(30) Foreign Application Priority Data
Aug. 23, 2019 (CN) 201910781594.7

(51) Int. Cl. C09J 7/30; E04F 13/00; C09J 7/29; C09J 7/21; C09J 11/04; C09J 11/08; B32B 27/30; B32B 27/10; B32B 7/12

(52) U.S. Cl. CPC C09J 7/30; E04F 13/002; C09J 7/29; C09J 7/21; C09J 11/04; C09J 11/08; B32B 27/306; B32B 27/10; B32B 7/12; C09J 2400/283; C09J 2429/00; B32B 2255/26; B32B 2255/10; B32B 2307/7166; B32B 2307/718; B32B 2607/02; B32B 2307/412

(57) ABSTRACT

A wall covering comprising a planar substrate having a front and a back facing opposite the front and an adhesive layer that covers the back of the substrate. The adhesive layer includes a separate polymer layer, formed by a polyvinyl alcohol polymer. Wall covering for example in the form of a pre-pasted paper is readily reactivated when wet, and exhibits no blocking, while having properties of sliding, adhesion, and stripability.

### Field of Invention

The present invention relates to wall coverings. In particular, the present invention concerns a wall covering comprising a planar substrate with a front and a back facing opposite the front, and a water activated adhesive layer at least partially covering the back of the substrate. The invention also relates to a method of producing wall coverings.

### Background

Adhesives for wall coverings are typically based on pre-pasted CMC and Starch, CMC combined with Starch, or pressure sensitive adhesive formulations. For example, U.S. Pat. No. 4,355,074 discloses the use of a swellable polymer, NaCMC, as an adhesive.

Pre-pasted wall cover papers are also known in the art. Such papers contain an adhesive layer applied to the back of the wall covering paper which is reactivated by water.

Examples of pre-pasted wall cover papers can be found in EP 705 896A1, U.S. Pat. Nos. 3,200,094A, 3,574,153A, 4,140,668A, 5,296,535A, 5,387,641A, 7,235,608B2, 8,263,689B2, WO2017/021720A1, WO2005/095712A1, GB 1,184,563.

Present products are difficult to use. For example pre-pasted starch paper has to be soaked for tens of minutes to reactivate the glue. Some are quite expensive. Examples of such products include pre-pastes utilizing super absorbent polymers (SAPs). In case of some pre-pastes which use very high water-retention polymers, there can further be high production costs due to production difficulties, as well as converting or packaging. Some existing pre-pasted solutions use ingredients that have no REACH certificates. Such components frequently are either environmentally hazardous or hazardous to health, and can be used only in small quantities.

Present products are also hampered by incomplete strip-ability resulting in delamination and tearing of the wallpapers when they are removed.

As apparent from the foregoing overview, the wall covering adhesives proposed so far are deficient in many aspects. The compositions suggested are complex, requiring a number of components, and elaborate techniques are needed for application of the adhesive layer on the back side of the wall covering.

Further, the studied compositions contain components which are irreversibly changed after application of the wall covering against the desired surface which makes it difficult to remove wall coverings once they have adhered to the surface.

### SUMMARY OF THE INVENTION

It is an aim of the present invention to provide a novel pre-pasted wall covering that provides good adhesion to the wall, while still avoiding that the adhesive applied on the wall covering during manufacture penetrates too deeply into the substrate, typically paper and, under the worse conditions, that the front side of the substrate has glue on it.

It is another aim of the invention to provide a method of producing wall coverings.

The present invention is based on the concept of providing a wall covering in the form of a pre-pasted wall cover, comprising a planar substrate having a front and a back facing opposite the front, and arranging on the back side of the substrate an adhesive layer which includes a polyvinyl alcohol polymer. The polyvinyl alcohol polymer is preferably cold water soluble.

The adhesive layer, although being part of the wall covering, is still separate from the substrate, such as paper sheet or web, so as to avoid-that water used for remoistening the bottom side is absorbed by the paper or that during printing of the wall cover paper using water-borne inks, if the water of the ink comes into contact with the bottom side glue and reactivates it. The latter is also known as a blocking phenomenon—a known problem which can cause significant issues during production or during use (for example, if the glue has been inadvertently activated during printing, and the wall cover roll is wound up, it cannot be unrolled for use by the converter or the user).

The present invention also provides for lamination of wall cover substrates with a separate film of polyvinyl alcohol as well as for coating of pre-coated substrates with a separate layer of polyvinyl alcohol.

More specifically, the present invention is mainly characterized by what is stated in the characterizing parts of the independent claims.

Considerable advantages are obtained by the invention. At least in some embodiments, the pre-pasted paper made according to the invention has properties of easy reactivation when wet, no—or only minor—blocking, good sliding, good adhesion, and good strip-ability.

At least in some embodiments, “good strip-ability” means that no delamination or tearing of the wall cover occurs during stripping-off of the wall cover. At least in some embodiments, “good strip-ability” means that the wall cover can be removed simply by dry-stripping, in particular without having tear or delamination.

Good sliding means the wall cover is repositionable easily during application. The adhesive layer has good transparency.

The present wall coverings are generally easy to manufacture, and the ready product is easy to use for the customer and fully affordable. The present wall covering does not give rise to hazards to the environmental or human health since it can be produced using only REACH certificated ingredients.

There are two basically different ways of producing the materials, viz. by lamination and by coating.

Laminating water soluble PVOH films to a paper substrate is a particularly efficient way of producing the present materials securing an even and reasonably thick film which gives good adhesive properties without interfering with the substrate.

By coating, using an intermediate pre-coating layer, good adhesive properties are also reached. The pre-coating layer will prevent penetration of the adhesive into the -substrate and, on the other hand, will form a barrier against water penetrating through the substrate and migrating into the adhesive component.

In embodiments in which the adhesive is applied in the form of a pre-formed film by lamination , the adhesive does not penetrate into the substrate layer during application.

In both embodiments, an adhesive is provided, pre-pasted onto a substrate, that does not share the disadvantages of pressure-sensitive glues, super absorbent polymers, polyacrylates or poly(acrylic acid) sodium salts or glues containing starch or derivatives of cellulose.

The adhesive, provided either as a coating or laminate, is quickly reactivated with water to allow for pasting onto specific surfaces, i.e. the wall cover can be characterized as a “pre-pasted wall cover”. More specifically the product of the current invention can be described as a “water activated pre-pasted wall cover”.

The adhesive component of the wall covering can be manufactured in the embodiment, where the PVOH is applied by coating, for example using a coating saucer. In the embodiment, wherein PVOH is applied by lamination, a pre-formed PVOH film can be separately provided, for example by suppliers.

Further details and advantages of embodiments will appear from the following description.

### BRIEF DESCRIPTION OF THE DRAWINGS

FIG. 1 shows in side view the structure of a wall covering according to a first embodiment;

FIG. 2 shows in side view the structure of a wall covering according to a second embodiment; and

FIG. 3 shows in side view the structure of a wall covering according to a third embodiment.

### EMBODIMENTS

As discussed above, a wall covering according to the present technology comprises a planar substrate, such as a non-woven or paper substrate, or a similar fibrous sheet having a front and a back side facing opposite the front. It further comprises an adhesive layer on the back side of the substrate.

The adhesive layer includes a separate polymer layer, formed by a polyvinyl alcohol polymer. Preferably, the polyvinyl alcohol polymer is a cold-water soluble polyvinyl alcohol polymer.

In the present context, the term “separate” implies that the forming of the layer takes place “separately” from the surface of the substrate, i.e. that the layer is not, as such, formed on the surface of the substrate.

Thus, the polymer layer is either a film, i.e. a preformed film, applied on the substrate as an integral (self-supporting) film, or the layer is formed on a surface separate from the back surface of the substrate. In the latter case, the polyvinyl alcohol layer is formed on a pre-coating layer covering the back of the substrate.

In one embodiment, a suitable polyvinyl alcohol polymer comprises a partially hydrolyzed alcohol polyvinyl polymer exhibiting a hydrolyzation degree of 50 to 90%, for example about 70 to 90%, for example about 80 to 90%.

Due to the partial hydrolysis of the polyvinyl alcohol, the polymer can also be considered a copolymer of polyvinyl alcohol (PVOH) and polyvinyl acetate (PVAc); i.e., partially hydrolyzed polyvinyl alcohol can be referred to as a “PVOH-PVAc copolymer”.

The molecular weight (M_{w}) of the polyvinyl alcohol, is generally in the range of 5,000 to 350,000 g/mol, for example 10,000 to 300,000 g/mol.

In one preferred embodiment the PVOH is cold water soluble. “Cold-Water Soluble Polyvinyl Alcohol” is a polymer soluble in water at room temperature or at a temperature up to about 40 ° C. Typically, the polymer, in powder form, will fully dissolve in water at neutral pH at a concentration of about 2 weight-% during the course of 60 minutes with agitation at the rate of 300 revolutions per minute. In more preferred embodiments the PVOH is fully dissolvable at less than 25° C. and in most preferred embodiments the PVOH is fully dissolvable at less than 15° C. in above conditions. Typically, a cold-water soluble polyvinyl alcohol is a partially hydrolyzed polyvinyl alcohol polymer which optionally contains co-monomer(s). These co-monomers may, for example be ionic monomers such as vinylic sulfonic acid monomers, vinylic carboxylic acid monomers, alkali metal salts of sulfonic acid monomers, alkali metal salts of carboxylic acid monomers and combination thereof.

The polyvinyl alcohol forms an adhesive layer on the back side of a wall paper substrate to allow for easy pasting of the wall paper onto a wall.

In one embodiment, the adhesive layer is transparent or translucent, preferably at least essentially transparent. This will allow for inspection, in particular visual inspection, of the back side of the substrate (wall-cover) or barrier layer, for example for detecting and analyzing any markings Thus, in one embodiment, the back side of the substrate or barrier layer is provided with visual markings or markings detectable with UV light. Such markings can be authenticity markings to allow for copy protection.

Generally, the substrate is comprised of cellulosic and/or polymeric fibers bonded together thermally, mechanically, chemically (with a binder), or a combinations thereof.

In one embodiment, the planar substrate, which forms the outer layer of the product, is a standard wall cover of the kind that may absorb water. It can be in the form of a sheet or web. The wall cover for example comprises a nonwoven substrate or a paper, a board or a similar sheet or a web. The nonwoven or paper substrate may preferably be produced by wet laid technologies. In the present context, “wet laid technology” comprises manufacture involving the steps of dispersing fibers in water, and draining, retaining and consolidating them randomly on a wire, then drying and bonding the fibers together. The nonwoven may typically be wet laid, but any method of forming nonwovens may be used. Various other planar substrates are also possible, including but not limited to woven materials.

The substrate can be formed from fibres selected from the group consisting of natural fibres, synthetic fibres and mixtures thereof. The thickness of the substrate can vary broadly between about 0.04 to 5 mm, in particular 0.2 to 2 mm The surface weight (also referred to as “basis weight” or “grammage”) can vary in the range from about 30 to 500 g/m², for example 40 to 300 g/m².

In the present context, “natural fibres” refer to fibres which occur naturally, for example those obtained from plant sources. Some examples of natural fibres are cotton, flax, abaca, jute, silk, and wool. “Synthetic fibres” refer to modified or regenerated natural fibers, artificial polymer fibers, and artificial non-polymer fibres. Examples of modified natural fibres include rayon/viscose, lyocell, and cellulose acetate fibres. Examples of artificial polymer fibres include polyester, polyamide, acrylic, vinyl, aramid, and polypropylene fibres. Examples of artificial non-polymer fibres include mineral fibres, glass fibres, and carbon fibres.

In one embodiment, the substrate comprises cellulose pulp at about 20% to 100% by weight and natural fibers or synthetic fibers at 0% to 80% by weight. Typically the substrate has a basis weight of from about 50 g/m² to about 300 g/m².

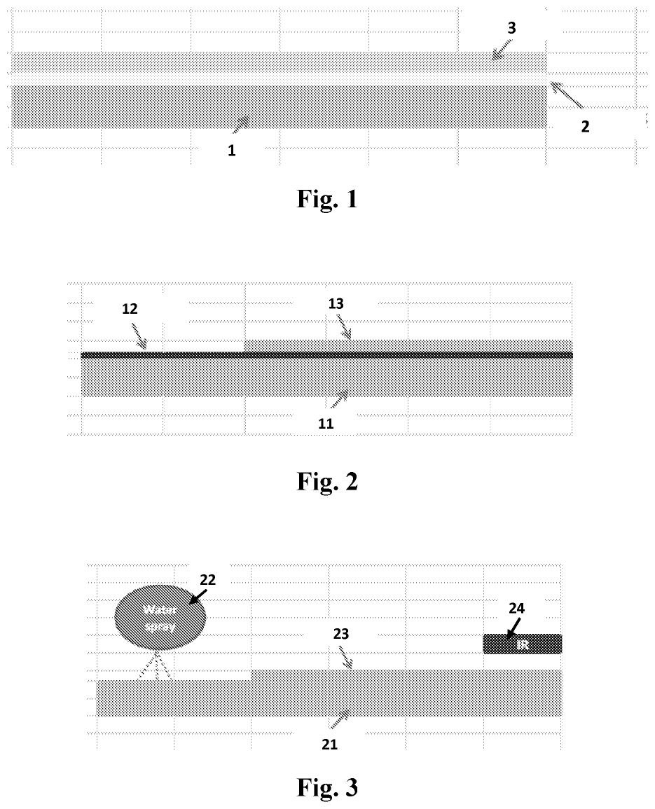

In a first embodiment, the polyvinyl alcohol polymer is applied on a paper or paperboard or nonwoven substrate by means of coating. This embodiment is illustrated in the FIG. 1.

Generally, the method of preparing a wall covering comprises the steps of
providing a planar substrate having a front and a back facing opposite the front; and
providing, as a separate layer, an adhesive layer which at least partially covers the back of the substrate,

wherein the adhesive layer is formed by a polyvinyl alcohol polymer.

In one embodiment, the method comprises the steps of
providing a planar substrate,
applying a first layer on the back of the substrate, and
applying on top of the first layer a second, polymer layer which includes a polyvinyl alcohol polymer capable of conferring adhesive properties to the second layer.

In one embodiment, the method comprises the steps of applying on the back of the substrate a film of a polyvinyl alcohol. The polyvinyl alcohol film can be attached directly onto the back of the planar substrate. The polyvinyl alcohol film can also be attached onto the back of the planar substrate using a glue layer.

FIG. 1 shows a three-layered structure consisting of a substrate 1 provided with a pre-coating 2 on top of which there is a top coating 3 which comprises an adhesive component, i.e. partially hydrolyzed polyvinyl alcohol.

The paper or non-woven substrate 1 comprises for example cellulose pulp at a concentration of 20% to 100% by weight optionally together with other natural fibers or synthetic fibers in amounts of 0% to 80% by weight. Generally, the basis weight of the substrate may range from about 50 g/m² to 300 g/m².

The back side of the substrate is treated with a pre-coating at a pickup of, typically, 3 to 50 g/m². The pre-coating can comprise a conventional coating colour. In one embodiment, the pre-coating includes a binder, a pigment and a viscosity modifier.

In one embodiment, the pre-coating layer comprises a binder, preferably a polymeric binder, for example a cross-linkable polymeric binder. The binder can be of a conventional type for coating colours. Examples include styrene butadiene rubber and acrylic binders.

The pre-coating layer also comprises a pigment which confers barrier properties to the layer. Examples suitable pigments include plate-like pigments, such as kaolin clay, delaminated clay, engineered clay, talc and combinations thereof. The aspect ratio of the pigment is typically 60 to 200. Naturally, the pre-coating layer forming a barrier layer may also comprise other (non-plate-like) pigments and fillers, which in particular modify the flow properties of the layer. The concentration of the pigment is suitable between 5-100 parts of clay relative to 100 parts of the dry weight of the binder.

Additionally the pre-coating layer may comprise of a viscosity modifier. Viscosity modifiers alter the rheology of a fluid composition, and can adjust flow properties and prevent particle sedimentation. Typical viscosity modifiers include, for example, derivatives of acrylic polymers, cellulose ethers, and gums. The particular viscosity modifier used is based on its compatibility with the other components of the pre-coating. Suitable quantities depend on the final viscosity required for application, but for example may be between 0.5-5 parts solids relative to 100 parts in dry weight of the binder.

The pre-coating layer can be applied on the back of the substrate for example by gravure, roll coat, Meyer rod, and saturation, screen, spray, blade and air knife coating on the substrate a coating formulation comprising a binder and at least one plate-like pigment, capable of forming a barrier layer which is water resistant but permeable to vapor.

The pre-coating layer may be provided by one or multiple applications of the pre-coating composition.

The pre-coating layer thus achieved is water resistant while still being permeable to vapor, such as water steam. In one embodiment, the water resistant barrier layer has a COBB60 value in the range of 3 to 50 g/m², preferably in the range of 8 to 30 g/m², as determined using ISO 535.

On top of the pre-coating there is arranged a top coating 3 (typically with a pickup of 2 to 25 g/m²). The coating is carried out using an aqueous composition of partially hydrolyzed polyvinyl alcohol, as discussed above, which may be mixed with one or several of the following optional components:
a. Cross-linker (a.k.a. cross-linking agent), for example glyoxal
b. Talc
c. Wax and or alkyl ketene dimer (AKD) and or alkenylsuccinic anhydride (ASA) and/or surface sizing agent (such as the styrene acrylate copolymer).

Component “a”, may be applied in the amounts of 0.1-10%, component “c”; may be applied in the amounts of 0.1-20%; while component “b” may be applied in amounts of up to 2 times (200%) in dry weight relative to dry weight of the polymeric component (i.e. the partially hydrolyzed polyvinyl alcohol).

The composition can be applied by, for example, air blade coating, also other types including champion bar, gravure, screen rolls, film press. In one embodiment, trailing blade is used.

In an embodiment, where the coating is applied by Air Blade Coating, the viscosity of the aqueous coating composition should preferably be between 200-300 cps. For film press application, a viscosity of about 100-200 cps is preferred and for rod coating, a broad range of viscosities from about 200 to 3000 cps are applicable.

The top-coating contains, after drying of the coated product, typically about 0.5 to 15 g/m², in particular 1 to 6 g/m², of polyvinyl alcohol polymer.

The use of the pre-coating gives important advantages.

In conjunction with the adhesive component, the polyvinyl alcohol, the pre-coating prevents the top coating (adhesive) from penetrating into the substrate (sheet) and assists in keeping the front side of the substrate free from adhesive (glue).

Further, it prevents water used for remoistening the bottom side from being too quickly absorbed by the substrate which would otherwise lead to a loss of the “slide” effect that is required for repositioning (easy adjustment of the paper stripes).

As a third advantage it can be noted that the pre-coating prevents the water contained in aqueous printing inks from migrating through the substrate layer and contacting with the glue on the back side and reactivating it (blocking phenomenon)

FIG. 2 shows a pre-pasted wall cover formed with three layers.

Thus, a paper or nonwoven substrate 11 comprising for example cellulose pulp between about 20% to 100% by weight and other natural fibers or synthetic fibers 0% to 80% by weight. The basis weight of the substrate is typically from about 50 g/m² to about 300 g/m².

A first layer comprising a glue, in particular a hot melt glue 12, is applied on the substrate 11. The hot melt glue may for example comprise polyurethane or a similar hot melt glue which has a melting point in the range from about 60° C. to about 160° C. Generally, any hot melt glue with a lower melting point than that of the polyvinyl alcohol (about 200° C.) may be used.

A second layer is formed on top of the glue layer 12 and tied to the substrate 11 with the aid of the glue layer, viz. a PVOH film 13. The PVOH film is typically water-soluble at room temperature. It can have a grammage of about 10 g/m² to 100 g/m². Typically a thickness of about 1 μm to 150 μm is desirable. More preferably, a thickness between 5 μm to 150 μm is considered sufficient to achieve a moisture activated PVOH film glue layer on the substrate 11.

In another embodiment, shown in FIG. 3, a PVOH film is laminated on a substrate by spraying water 22 and followed by a drying step using IR heating 24 or other devices, such as air tunnel or air dryer.

Thus, just as in the above embodiments, the substrate 21 comprises a paper or nonwoven sheet or web comprising cellulose pulp between at about 20% to 100% by weight and other natural fibers or synthetic fibers at 0% to 80% by weight. Typically, the basis weight may range from about 50 g/m² to 300 g/m².

A PVOH film 23 is applied on the substrate. Typically, the PVOH film is water-soluble at room temperature. The grammage is, for example, about 10 g/m² to 100 g/m². The thickness of the film is typically about 5 μm to 150 μm, for example 10 to 150 μm.

The properties of a suitable PVOH film are given below in Table 1.

TABLE 1

| | | | Tensile | | |
|---|---|---|---|---|---|
| Grammage | Thickness | Tear | strength | Elongation | Stiffness |
| <40 gsm | <30 μm | >800 gf | >500 N/m | >100% | low |

The following illustrative examples are non-limiting.

### EXAMPLES

### Example 1

In a trial, a product according to FIG. 1 was produced using PVOH in the top-coating, applying about 2-3 g/m². The PVOH used was a partially hydrolyzed PVOH (Kuraray Poval™48-80). The binder used in the pre-coating was a cross-linkable styrene acrylic polymer (Dow Primal™ NW-1845 K). For compatibility, the viscosity modifier used was an acrylic-based emulsion (Synthron TPC-38).

The components are given in Table 2:

TABLE 2

| Pre- | | | | Viscosity | Final | Total Pick- |
|---|---|---|---|---|---|---|
| Coating | Latex | | Clay | Modifier | Viscosity | up |
| Type | Acrylic | | | | | |
| Parts | 100 | — | 40 | 1.85 | 400 cP | 2×7 g/m² |
| Top- | | | | | Final | Total Pick- |
| Coating | PVOH | Talc | Wax | Xlinker | Viscosity | up |
| | 48-80 | — | — | — | 400 cP | 2-3 g/m² |
| Parts | 100 | | | | | |

All parts are given on a dry weight basis

The substrate was a paper having a grammage of 140 g/m². The pick-up of the pre-coating was 14 g/m² (coated twice at 7 gsm) and of the top coating about 2 g/m² by Champion Coater. Thus, the total grammage of the final product was about 155 g/m^{2.} Thickness was 300 μm and air permeability was less than 5 (1/m²/s) by ASTM D737.

The product was tested for wall application with 30% water by weight of the substrate. Reactivation, stripability, blocking, and transparency were excellent ( 4/4) whereas sliding and adhesion were fair (¼).

### Example 2

A wall covering as depicted in FIG. 2 was manufactured using hot-melt glue to laminate a PVOH film to the substrate.

The hot-melt glue was polyurethane (Jowatherm-Reaktant® 630.80), applied using gravure roll.

A commercially available cold-water soluble PVOH copolymer film (-VH-H929 Film, supplied by Monosol (A division of Kuraray) was used for lamination. The film is water soluble at a low temperature such as 10-20° C.

The substrate was a paper having a grammage of 143 g/m². The pick-up of glue was about 6 g/m² and the grammage of the film was 45 g/m². Thus, the total grammage of the final product was 194 g/m². Thickness was 305 μm.

The product was tested for wall application with 30% water by weight of the substrate. Reactivation, blocking and transparency were excellent (4/4), whereas sliding and stripability were modest ( 2/4) and adhesion was good (¾).

### REFERENCE NUMERALS

1 Substrate

2 Pre-coating

3 Adhesive layer

11 Substrate

12 Glue layer

13 Laminate film

21 Substrate

22 Water spray head

23 Laminate film

24 Heater

1. A wall covering comprising
a planar substrate having a front and a back facing opposite the front; and
an adhesive layer which at least partially covers the back of the substrate, wherein the adhesive layer includes a separate polymer layer, formed by a polyvinyl alcohol polymer.

2. The wall covering according to claim 1, wherein the polyvinyl alcohol polymer is cold-water soluble.

3. The wall covering according to claim 1, wherein the polyvinyl alcohol polymer comprises a partially hydrolyzed polyvinyl alcohol polymer which optionally contains comonomer(s).

4. The wall covering according to claim 1, wherein the polyvinyl alcohol polymer, comprises a partially hydrolyzed alcohol polyvinyl polymer exhibiting a hydrolyzation degree of 50 to 90%.

5. The wall covering according to claim 1, comprising
the planar substrate,
a first layer on the back of the substrate, and
on top of the first layer a second, polymer layer which includes a cold-water soluble polyvinyl alcohol polymer capable of conferring adhesive properties to the second layer.

6. The wall covering according to claim 5, wherein the second layer contains a partially hydrolyzed polyvinyl alcohol having a degree of hydrolysis of 50 to 90%.

7. The wall covering according to claim 5, wherein the second layer contains a partially hydrolyzed polyvinyl alcohol together with at least one additional component selected from the group of cross-linkers, pigments, talc, viscosity modifying agents, wax, or sizing agents and combinations thereof.

8. The wall covering according to claim 1, wherein the back of the substrate is coated with a coating colour containing at least a binder and a pigment.
wherein the coating colour forms a barrier layer separating the back of the substrate from the polymer layer containing cold-water soluble polyvinyl alcohol polymer;
wherein the barrier layer has a grammage of 3 g/m² to 50 g/m².

9. (canceled)

10. (canceled)

11. The wall covering according to claim 1, wherein the adhesive layer comprises a film of a polyvinyl alcohol; and
comprising a laminate formed by the planar substrate and the polyvinyl alcohol film;
wherein the polyvinyl alcohol film is attached to the back of the planar substrate directly or by a glue layer.

12. (canceled)

13. (canceled)

14. The wall covering according to claim 1, wherein the substrate is selected from the group of nonwoven substrates, papers and boards.

15. The wall covering according to claim 1, wherein the substrate comprises cellulose pulp at about 20% to 100% by weight and natural fibers or synthetic fibers at 0% to 80% by weight, said substrate having a basis weight of from about 50 g/m² to about 300 g/m².

16. The wall covering according to claim 1, wherein the thickness of the adhesive layer is about 1 μm to 150 μm, for cxamplc 5 μm to 150 μm.

17. The wall covering according to claim 1, wherein the adhesive layer contains 0.1 to 5 g/m², of polyvinyl alcohol polymer.

18. The wall covering according to claim 1, wherein the adhesive layer is transparent and
comprising on the back side of the substrate markings which can be detectable visually or with UV light from the side of the adhesive layer.

19. (canceled)

20. The wall covering according to claim 1, being a pre-pasted wallcover.

21. A method of preparing a wall covering comprising the steps of
providing a planar substrate having a front and a back facing opposite the front; and
providing, as a separate layer, an adhesive layer which at least partially covers the back of the substrate,
wherein the adhesive layer is formed by a polyvinyl alcohol polymer.

22. The method according to claim 21, comprising the steps of providing the planar substrate,
applying a first layer on the back of the substrate, and
applying on top of the first layer a second, polymer layer which includes a polyvinyl
alcohol polymer capable of conferring adhesive properties to the second layer.

23. The method according to claim 22, comprising applying on the first layer 0.1 to 5 g/m², of polyvinyl alcohol polymer to form the second layer.

24. The method according to claim 22, wherein the second layer contains a partially hydrolyzed polyvinyl alcohol having a degree of hydrolysis of 50 to 90%.

25. The method according to claim 22, wherein the second layer contains a partially hydrolyzed polyvinyl alcohol together with at least one additional component selected from the group of cross-linkers, pigments, talc, viscosity modifying agents, wax, or sizing agents, and combinations thereof.

26. The method according to claim 21, comprising coating the back of the substrate with a coating colour containing at least a binder, and a pigment;
wherein the coating colour forms a barrier layer separating the back of the substrate from the polymer layer containing the polyvinyl alcohol polymer; and
comprising applying 3 to 50 g/m² of the coating colour on the back of the substrate so as to form the barrier layer which separates the polymer layer from the substrate.

27. (canceled)

28. (canceled)

29. The method according to claim 21, comprising applying on the back of the substrate a film of a polyvinyl alcohol;
wherein a laminate is formed, comprising the planar substrate and the polyvinyl alcohol film attached to the substrate;
comprising attaching the polyvinyl alcohol film directly onto the back of the planar substrate or attaching the polyvinyl alcohol film to the back of the planar substrate by a glue layer.

30. (canceled)

31. (canceled)

32. (canceled)

33. The method according to claim 21, comprising applying on the back of the substrate a film of a polyvinyl alcohol, having a thickness of about 1 μm to 150 μm.

34. The method according to claim 21, comprising applying on the back of the substrate an adhesive layer which is transparent
comprising forming on the back side of the substrate markings, which are detectable visually or with UV light from the side of the adhesive layer.

35. (canceled)
